(19) United States
(12) Patent Application Publication
(10) Pub. No.: US 2022/0269986 A1
(43) Pub. Date: Aug. 25, 2022

(54) System and Method for Automated Prediction of Event Probabilities with Model Based Filtering

(71) Applicant: Anton Filikov, Burlington, MA (US)

(72) Inventor: Anton Filikov, Burlington, MA (US)

(21) Appl. No.: 17/249,177

(22) Filed: Feb. 23, 2021

(51) Int. Cl. G06N 20/00

(52) U.S. Cl. CPC G06N 20/00

(57) ABSTRACT

The invention relates to methods of determination of probabilities of events. A probability score is calculated for a data point if the point is classified as “predictable” by a pre-filter model. The score indicates probability of a certain type of event. In addition, methods are disclosed that teach how to build the sub-models and the meta model. The invention discloses a meta model with model-based pre-filtering that takes a set of other (non-meta or meta) “algorithms” and constructs a new algorithm out of those. The meta-model combines other models that predict two different labels: The 1st sub-model learns predictability. The 2nd sub-model is used to filter out “unpredictable” points from new data. The “predictable” part of the data flows into the 3rd sub-model (trained on “predictable” data) that predicts probability score.

### TECHNICAL FIELD

The invention relates generally to systems and methods of using predictive computational modeling techniques in the field of calculating probability scores of events in various industries, projects, applications and material processes.

The SCL model is capable of improving some performance metrics, but these improvements are only provided for a part of the data set that is “easier” to predict.

### BACKGROUND

In many applications it is important to predict probabilities of certain type of events with high quality. Examples of predictive models used for this purpose can be (but not limited to) binary or multi-class classifiers. Often known predictive methods are only capable of providing predictions of a certain quality that is lower than desired. In such situations the system and method disclosed in the current invention can be used to calculate a higher quality probability scores.

### SUMMARY

The present invention relates to a system and method of the quantitative determination of probabilities of events. A probability score is calculated by a predictive model for a data point if the data point is classified as “predictable” by a predictive pre-filter model. The probability score is then used to identify whether the data point is likely to experience a certain type of event. In addition, methods are disclosed that teach how to build the predictive pre-filter model and the final predictive model.

### BRIEF DESCRIPTION OF THE DRAWINGS

The method and system according to the invention will now be described in more detail with regard to the accompanying figures. The figures show one way of implementing the present invention and is not to be construed as being limiting to other possible embodiments falling within the scope of the attached claim set.

FIG. 1. This flowchart shows how regular predictive models are built on a training data set and run to make predictions for new data points.

FIG. 2. This flowchart shows how predictive model with model-based pre-filtering is built on a training data set and run to make predictions for new data points.

FIG. 3. ROC curves for 5 runs of regular random forest model.

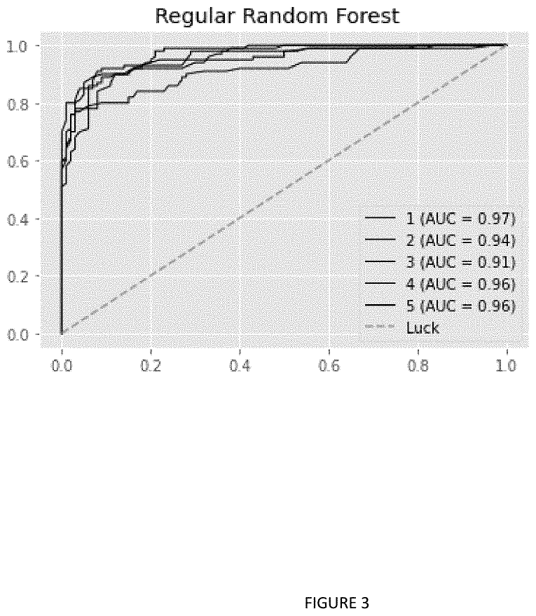

FIG. 4. ROC curves for 5 runs of MMBPF meta-model with threshold of predictability=0.5.

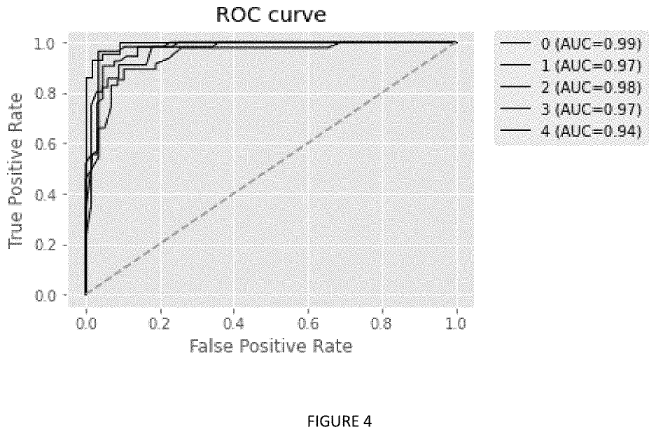

FIG. 5. ROC curves for 5 runs of MMBPF meta-model with threshold of predictability=0.7.

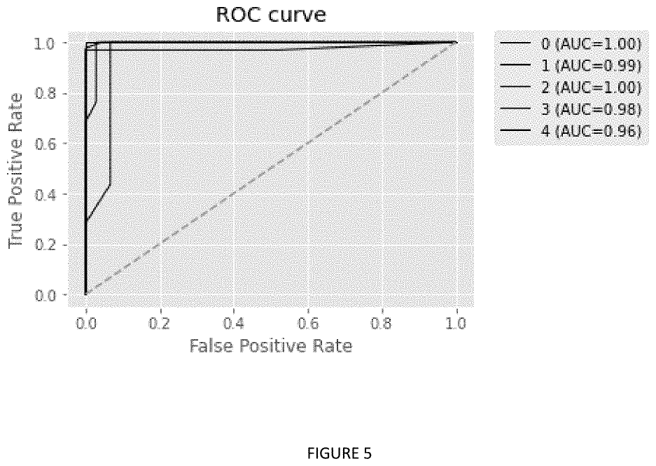

FIG. 6. ROC curves for 5 runs of MMBPF meta-model with threshold of predictability=0.8.

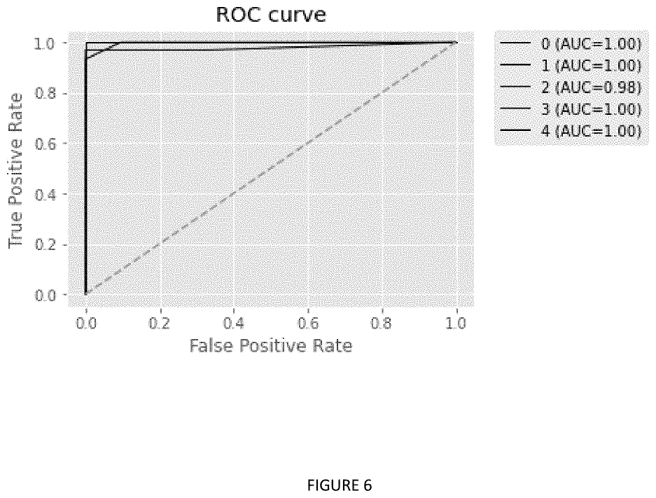

### DETAILED DESCRIPTION

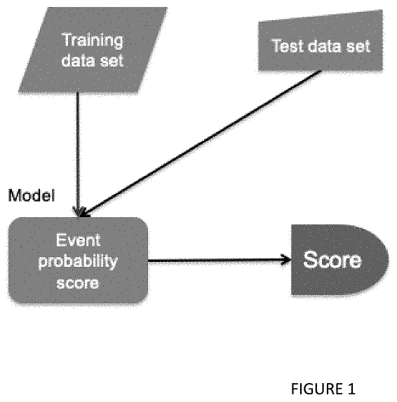

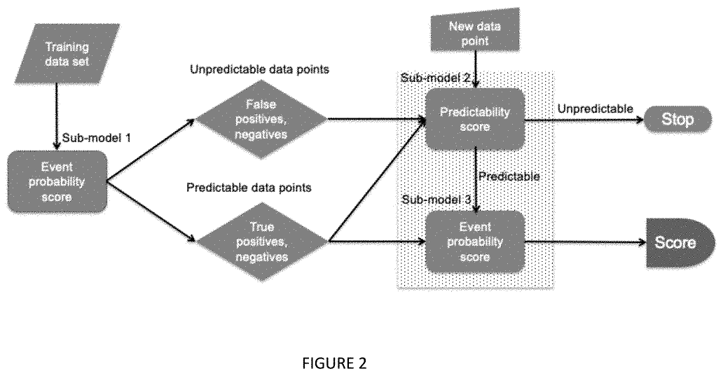

Regular predictive models are built on a training data set and used to make predictions for new data points (see FIG. 1). The current invention describes a novel approach that may give better predictions for new data points because it uses a model-based pre-filtering to separate new data point into predictable and unpredictable so that better predictions can be made for the predictable data points (see FIG. 2).

The model with model-based pre-filtering uses three sub-models (see FIG. 2):
Sub-model 1 (built on training set) classifies data points into “predictable” and “unpredictable”,
Sub-model 2 (built on all data points from the training set) classifies new data points (test set) into “predictable” and “unpredictable” and
Sub-model 3 (built on “predictable” subset of the training set) predicts the event probability score for the subset of the test set classified as “predictable” by Sub-model 2.

The model with model-based pre-filtering (MMBPF) is a meta-model since it takes a set of other (non-meta or meta) “algorithms” and constructs a new algorithm out of those. Examples of known meta-algorithms are: multiplicative weights, weighted majority, boosting, bagging, stacking, ensemble averaging, voting. The MMBPF model may be homogeneous or heterogeneous.

DIFFERENCE BETWEEN MMBPF AND KNOWN META-MODELS. All known meta-models construct new models by combining other models that predict the same target/label. The MMBPF meta-model has a different design—it constructs new models by combining other models that predict two different targets/labels: The 1st sub-model learns predictability. This sub-model is used to filter out “unpredictable” points from test (or new) data. The “predictable” part of the data flows into the 3rd sub-model (trained on the “predictable” fraction of the training set) that predicts the target/label of interest (e.g. probability of an event).

PERFORMANCE OF THE MMBPF MODEL MAY BE BETTER THAN ANY OTHER MODEL. The MMBPF meta-model can be based on any other meta or non-meta, ensemble or non-ensemble models. In order to prove that performance of the MMBPF meta-model is always better or the same as any other model, let us assume that there is a model (model A) that performs best on some data. In order to beat the performance of model A we just need to build the MMBPF meta-model on model A—so that the sub-model 3 works on the same algorithm as model A. In this case the performance of the MMBPF meta-model cannot be worse than the performance of model A—simply because the newly constructed MMBPF meta-model IS model A, but working on the part of the data that is easier to predict. Therefore its performance is always better or the same as model A (or any other existing or future model).

### Definitions

A META-ALGORITHM. A meta-algorithm, in the context of learning theory, is an algorithm that decides how to take a set of other (typically, though not necessarily non-meta) “algorithms”, and constructs a new algorithm out of those, often by combining or weighting the outputs of the component algorithms. Examples of meta-algorithms are: multiplicative weights, weighted majority, boosting, bagging, stacking, ensemble averaging, voting

ENSEMBLE METHODS. Ensemble methods are meta-algorithms that combine several machine learning techniques into one predictive model in order to improve performance, e.g. to decrease variance (bagging), bias (boosting), or improve predictions (stacking).

SEQUENTIAL ENSEMBLE methods where the base learners are generated sequentially (e.g. AdaBoost). The basic motivation of sequential methods is to exploit the dependence between the base learners. The overall performance can be boosted by weighing previously mislabeled examples with higher weight.

PARALLEL ENSEMBLE methods where the base learners are generated in parallel (e.g. Random Forest). The basic motivation of parallel methods is to exploit independence between the base learners since the error can be reduced dramatically by averaging.

HOMOGENEOUS ENSEMBLES. Most ensemble methods use a single base learning algorithm to produce homogeneous base learners, i.e. learners of the same type, leading to homogeneous ensembles.

HETEROGENEOUS ENSEMBLES. There are also some methods that use heterogeneous learners, i.e. learners of different types, leading to heterogeneous ensembles.

BAGGING. Bagging stands for bootstrap aggregation. In order to reduce the variance of an estimate bagging averages together multiple estimates. Bagging uses bootstrap sampling to obtain the data subsets for training the base learners. For aggregating the outputs of base learners, bagging uses voting for classification and averaging for regression.

BOOSTING. Boosting refers to a family of algorithms that are able to convert weak learners to strong learners. The main principle of boosting is to fit a sequence of weak learners—models that are only slightly better than random guessing, such as small decision trees—to weighted versions of the data. More weight is given to examples that were misclassified by earlier rounds. The predictions are then combined through a weighted majority vote (classification) or a weighted sum (regression) to produce the final prediction. The principal difference between boosting and the committee methods, such as bagging, is that base learners are trained in sequence on a weighted version of the data.

STACKING. Stacking is an ensemble learning technique that combines multiple classification or regression models via a meta-classifier or a meta-regressor. The base level models are trained based on a complete training set, then the meta-model is trained on the outputs of the base level model as features. The base level often consists of different learning algorithms and therefore stacking ensembles are often heterogeneous.

### Detailed Description of an Embodiment

In order to demonstrate advantages of the disclosed system and method in comparison with known state of the art method the following is chosen:
Data set—a standard dataset for benchmarking predictive model, Title: Pima Indians Diabetes Database. Source: National Institute of Diabetes and Digestive and Kidney Diseases. The dataset is available from the source in reference 1. Previously the dataset was used in published works. One example is referenced in reference 2. Number of Instances: 768. Number of Attributes: 8 plus class. For Each Attribute: (all numeric-valued):
   1) Number of times pregnant,
   2) Plasma glucose concentration a 2 hours in an oral glucose tolerance test
   3) Diastolic blood pressure (mm Hg)
   4) Triceps skin fold thickness (mm)
   5) 2-Hour serum insulin (mu U/ml)
   6) Body mass index (weight in kg/(height in m)\hat{ }2)
   7) Diabetes pedigree function
   8) Age (years)
   9) Class variable (0 or 1)
The base learners for the regular model and for the disclosed MMBPF meta-model: Random forest. MMBPF meta-model can be built on any predictive modeling engine, Random forest is chosen because it is very common for predicting outcomes in healthcare as well as in many other fields. Random Forest Classifier used is the one from sklearn.ensemble library.

The regular model is built according to the flowchart depicted on FIG. 1. The MMBPF meta-model is built according to the flowchart depicted on FIG. 2. The dataset is split 80% vs 20% (training set vs testing set) in order to train the model followed by performance evaluation on the test set. The training-testing procedure is repeated 5 times and the results are averaged.

The regular random forest model produces the following results:

mean AUC=0.950, stdDev=0.021, stdErr=0.009
mean ACC=0.867, stdDev=0.021, stdErr=0.009
mean SEN=0.918, stdDev=0.061, stdErr=0.027
mean SPE=0.816, stdDev=0.027, stdErr=0.012

Explanation of abbreviations. AUC is area under the ROC curve, ACC is accuracy, SEN is sensitivity, SPE is specificity, stdDev is standard deviation, stdErr is standard error.

Feature ranking produce by the regular random forest model:

### Feature Ranking:

1. feature 1 GlucoseConc (0.269961)
2. feature 5 BMI (0.175204)
3. feature 7 Age (0.135466)
4. feature 6 DiabetesPedigreeFunct (0.118337)
5. feature 2 BloodPressure (0.085768)
6. feature 0 NoTimesPregnant (0.081992)
7. feature 4 Insulin (0.066720)
8. feature 3 SkinThickness (0.066551)

The MMBPF meta-model built on exactly the same random forest classifiers produces the following results (with threshold of predictability=0.5). Threshold of predictability is a user controlled parameter, it shows how close is predicted label to the actual label in sub-model 1. If it equals to 0.5 it means that only data points with predicted probability of 50% or less to the actual outcome are labeled as “predictable” by sub-model 1.

Performance of MMBPF meta-model with threshold of predictability=0.5 (“predictable” fraction is 57%):

mean AUC=0.971, stdDev=0.018, stdErr=0.008

mean ACC=0.914, stdDev=0.028, stdErr=0.013

mean SEN=0.941, stdDev=0.037, stdErr=0.017

mean SPE=0.892, stdDev=0.044, stdErr=0.020

One can see that all performance metrics of the MMBPF meta-model are 2% to 9% better than the metrics of the regular random forest model. This performance improvement was reached because the MMBPF meta-model makes prediction not on the whole data set, but only on the fraction of the dataset labeled by sub-model 1 as “predictable”. In this embodiment the “predictable” fraction is 57% on average (5 runs).

In another embodiment with higher threshold of predictability performance of MMBPF meta-model gets even higher but the “predictable” fraction of the database gets smaller.

Performance of MMBPF meta-model with threshold of predictability=0.7 (“predictable” fraction is 33%):

mean AUC=0.985, stdDev=0.018, stdErr=0.008
mean ACC=0.985, stdDev=0.010, stdErr=0.005
mean SEN=0.994, stdDev=0.014, stdErr=0.006
mean SPE=0.972, stdDev=0.029, stdErr=0.013

In another embodiment with even higher threshold of predictability performance of MMBPF meta-model gets even higher but the “predictable” fraction of the database gets even smaller.

Performance of MMBPF meta-model with threshold of predictability=0.8 (“predictable” fraction is 24.5%):

mean AUC=0.995, stdDev=0.009, stdErr=0.004
mean ACC=0.988, stdDev=0.017, stdErr=0.008
mean SEN=0.981, stdDev=0.030, stdErr=0.013
mean SPE=1.000, stdDev=0.000, stdErr=0.000

Feature ranking produced by MMBPF meta-model is similar to the one produced by the regular random forest model. Below is feature ranking produced with threshold of predictability=0.8:

Feature Ranking:

1) feature 1 GlucoseConc (0.375448)
2) feature 7 Age (0.208284)
3) feature 5 BMI (0.185397)
4) feature 0 NoTimesPregnant (0.088778)
5) feature 6 DiabetesPedigreeFunct (0.044892)
6) feature 2 BloodPressure (0.036436)
7) feature 4 Insulin (0.033804)
8) feature 3 SkinThickness (0.026960)

### REFERENCED CITED

1. https://machinelarningmastery.com/standard-machine-learning-datasets/
2. Smith, J. W., Everhart, J. E., Dickson, W. C., Knowler, W. C., & Johannes, R. S. (1988). Using the ADAP learning algorithm to forecast the onset of diabetes mellitus. In Proceedings of the Symposium on Computer Applications and Medical Care (pp. 261-265). IEEE Computer Society Press.

### CROSS REFERENCE TO RELATED APPLICATIONS

A related Provisional patent application describing the invention described in the current disclosure was filed earlier. The following is its reference information.
Application Number: 62/980,938
Filing Date: Feb. 24, 2020
Inventor: Anton Filikov, Framingham
Assignee: Anton Filikov, Framingham

1. A method, comprising:
receiving a data set having multiple data points;
assigning, using a meta-model (e.g., a meta-model consisting of three sub-models that are built on any known modeling algorithms—the same or different algorithms for the sub-models), a risk value to each or to some data points in the data set using the following framework;
building the first model (e.g., sub-model 1), by training it with a set of data points having target value (the 1st training data set); and
generating the 2nd training data set for the second model (e.g., sub-model 2), by assigning to each data point a new target value (either “predictable” or “unpredictable”); and
generating the 3rd training data set for the third model (e.g., sub-model 3), by selecting a subset of data points from the 1st training data set that are successfully predicted by the first model (e.g., sub-model 1); and
building a second model (e.g., sub-model 2), by training it on the 2nd training data set; and
building a third model (e.g., sub-model 3), by training it on the 3rd training data set; and
determining, using the 2nd model (e.g., sub-model 2), a subset of data points (predictable subset) in a data set with unknown target values (an unseen data set) that are “predictable” (e.g. have a better probability of the value to be predicted in the 3rd model);
assigning, using the 3rd model (e.g., sub-model 3), a predicted probability value to each data point in the predictable subset.
